(19) United States
(12) Patent Application Publication
(10) Pub. No.: US 2021/0034207 A1
(43) Pub. Date: Feb. 4, 2021

(54) OPERATION IMAGE DISPLAY DEVICE, OPERATION IMAGE DISPLAY SYSTEM, AND OPERATION IMAGE DISPLAY PROGRAM

(71) Applicant: NIPPON SEIKI CO., LTD., Niigata (JP)

(72) Inventor: Tomoya KURAISHI, Niigata (JP)

(21) Appl. No.: 16/969,100

(22) PCT Filed: Mar. 8, 2019
(86) PCT No.: PCT/JP2019/009406

§ 371 Date: Aug. 11, 2020

(30) Foreign Application Priority Data
Mar. 12, 2018 (JP) 2018-043725

(51) Int. Cl. G06F 3/0484; B60K 35/00

(52) U.S. Cl. CPC G06F 3/0484; B60K 35/00; B60K 2370/52; B60K 2370/577; B60K 2370/115; B60K 2370/186; B60K 2370/1529; B60K 2370/151; B60K 2370/48

(57) ABSTRACT

The purpose of the present invention is to provide an operation image display device, an operation image display system, and an operation image display program for controlling the display of operation images according to the likelihood of a user using a function. An operation image display device is mounted in a vehicle and comprises: a display; a control unit; a vehicle information input/output unit; a storage unit; a sensor information acquisition unit; and an operation information acquisition unit. The control unit determines functions having a high likelihood of use, on the basis of at least one of vehicle information, sensor information, and operation history information, and selects and displays selection images corresponding to the functions having a high likelihood of use.

### TECHNICAL FIELD

The present invention relates to an operation image display device, an operation image display system, an operation image display program, and the like, installed in a vehicle such as an automobile.

### BACKGROUND ART

A driver driving a vehicle with a wheel (e.g., a steering wheel) preferably needs to operate a pointing device (operating unit) for the vehicle intuitively through touch typing to bring a menu image (operation image) into view and select an item in an extremely short time while carefully looking ahead.

For example, Patent Document 1 discloses a vehicle-mounted device operation system that enables a touch typing operation using a pointing device.

### PRIOR ART DOCUMENT

### Patent Document

Patent Document 1: Japanese Unexamined Patent Publication No. 2004-345549

### SUMMARY OF THE INVENTION

### Problems to be Solved by the Invention

According to the invention disclosed in Patent Document 1, regardless of the position of the driver's hand on the pointing device, the icon at the center is first selectively displayed among a plurality of icons displayed on the display. Then, the adjacent icon is selected due to the sliding of the driver's hand from the first position on the pointing device. In order to select an item in a short time, however, the driver needs to memorize the positions of many icons.

The present invention has an object to provide an operation image display device, an operation image display system, and an operation image display program with which the presentation of an operation image is controlled in accordance with the driver's likelihood of use of a function.

### Solution to Problem

An operation image display device according to a first aspect of the present invention includes: a display that presents an operation image including a selection image corresponding to a function; a control unit that controls presentation of the operation image; an operation information acquisition unit that acquires operation information of an operating unit; a vehicle information input/output unit that acquires vehicle information; a sensor information acquisition unit that acquires sensor information; a storage unit that stores operation history information in which the vehicle information and/or the sensor information is associated with the operation information, wherein the control unit determines the function with high likelihood of use based on at least one of the vehicle information, the sensor information, and the operation history information and selectively displays the selection image corresponding to the function with high likelihood of use.

In the operation image display device, as the function with the driver's high likelihood of use is determined and the selection image is selectively displayed, it is possible to reduce the driver's inconvenience for operating the operating unit and to make the driver concentrate on driving.

According to a second aspect dependent on the first aspect, when it is determined that an operation has not been performed for a period of time more than a threshold based on the operation information and the operation history information, the control unit selectively displays the selection image corresponding to the function with high likelihood of use.

In the operation image display device, when it is determined that an operation has not been performed for a period of time more than the threshold based on the operation information and the operation history information, the selection image corresponding to the function with high likelihood of use is selectively displayed so that the control is performed such that the selective display is prevented from changing while the driver is operating the operating unit.

According to a third aspect dependent on the first aspect or the second aspect, the control unit changes the threshold based on at least one of the vehicle information, the sensor information, and the operation history information.

In the operation image display device, as the threshold is determined in accordance with the vehicle information, the sensor information, and the operation information log, it is possible to use the threshold corresponding to the status of the vehicle.

According to a fourth aspect dependent on any one of the first aspect to the third aspect, the control unit determines that selective determination is made when a determination signal is acquired based on the operation information, and the control unit calculates an operating time from start of an operation to the selective determination based on the operation information and the operation history information and increases the threshold as the operating time increases.

In the operation image display device, as the threshold is increased in accordance with the time it takes for the driver to operate the operating unit, it is possible to use the threshold corresponding to the driver.

According to a fifth aspect dependent on any one of the first aspect to the fourth aspect, the operation image includes k (k being a natural number equal to or more than 2) or more layers.

In the operation image display device, as the operation image includes two or more layers, many selection images may be displayed.

According to a sixth aspect dependent on the fifth aspect, the control unit determines the function with low likelihood of use in an n-th layer and moves the selection image corresponding to the function with the low likelihood of use to an (n+m)-th layer (n and m being each a natural number equal to or more than 1, and n+m≤k is satisfied).

In the operation image display device, as the selection image corresponding to the function with low likelihood of use is moved to a lower layer, the selection range of the selection image corresponding to the function with high likelihood of use may be enlarged, and the selective display may be facilitated for the driver.

According to a seventh aspect dependent on the fifth aspect, the control unit determines the function with high likelihood of use in the (n+m)-th layer and moves the selection image corresponding to the function with high likelihood of use to the n-th layer (n and m being each a natural number equal to or more than 1, and n+m≤k is satisfied).

In the operation image display device, as the selection image corresponding to the function with high likelihood of use is moved to an upper layer, the control unit may selectively display the function with high likelihood of use, and the selective display may be facilitated for the driver.

According to an eighth aspect dependent on the sixth aspect or the seventh aspect, the control unit stores the specific selection image and the specific layer in the storage unit in association with each other, and the control unit refrains from moving the specific selection image from the specific layer based on the likelihood of use.

In the operation image display device, as the layer in which the specific selection image is disposed is fixed, the driver may reach the layer where the specific selection image is disposed without hesitation.

According to a ninth aspect dependent on the eighth aspect, the control unit causes the storage unit to further store a display position of the specific selection image.

In the operation image display device, as the position of the specific selection image to be displayed is fixed, the driver may cause the selection image to be selectively displayed through a touch typing operation.

According to a tenth aspect dependent on any one of the fifth aspect to the ninth aspect, the control unit causes the storage unit to store a maximum and/or a minimum number of the selection images displayed in the single layer.

In the operation image display device, the maximum and/or the minimum number of selection images displayed in one layer, which is stored in the storage unit, prevents the generation of an operation image in which many more selection images than necessary are arranged or an operation image in which no selection image is present.

According to an eleventh aspect dependent on the tenth aspect, the storage unit stores the maximum and/or the minimum number of the selection images displayed on a per-layer basis.

In the operation image display device, the operation image corresponding to the driver's preference may be displayed, for example, the number of frequently used selection images displayed in an upper layer is reduced, or the number of infrequently used selection images displayed in a lower layer may be increased.

According to a twelfth aspect dependent on the fifth aspect to the eleventh aspect, the control unit determines a function with high frequency of use based on the operation history information and enlarges a selection range of a selection image corresponding to the function with high frequency of use.

In the operation image display device, as the selection range of the selection image corresponding to the frequently used function is enlarged, the selective display of the selection image may be facilitated for the driver.

According to a thirteenth aspect dependent on the twelfth aspect, the control unit causes the storage unit to store the maximum and/or the minimum selection range.

In the operation image display device, the maximum and/or the minimum selection range of the selection image stored in the storage unit prevents the generation of an unnecessarily large selection image or a selection image that is too small to be selectively displayed for the driver.

According to a fourteenth aspect dependent on any one of the first aspect to the thirteenth aspect, the operating unit includes an operation position detecting unit that detects an operation position and a central determination operating unit in a center of the operation position detecting unit, and the control unit causes a selection determination image to be displayed in the center of the operation image.

In the operation image display device, it is possible to make the driver recognize that the selectively displayed selection image is selectively determined due to a pushing operation on the central determination operating unit in the center of the operation position detecting unit.

According to a fifteenth aspect dependent on any one of the first aspect to the fourteenth aspect, the control unit gives notification of a change in the presentation of the operation image.

In the operation image display device, it is possible to give notification so as to make the driver notice when the presentation of the operation image has been changed, for example, the selection image has been selectively displayed, the selection range of the selection image has been enlarged, or the layer of the selection image has been moved.

An operation image display system according to a sixteenth aspect dependent on any one of the first aspect to the fifteenth aspect includes: the operation image display device according to any one of claims 1 to 15; the operating unit that outputs the operation information; and a vehicle-mounted device and/or an external communication device having the function corresponding to the selection image.

In the operation image display system, for example, the driver driving the vehicle may comfortably operate the vehicle-mounted device and/or the external communication device through a touch typing operation.

An operation image display program according to a sixteenth aspect dependent on any one of the first aspect to the fifteenth aspect causes a computer to operate as the operation image display device according to any one of claims 1 to 16.

The operation image display program may perform the presentation control of the operation image with a simple configuration using a software program.

### Effect of the Invention

According to the present invention, it is possible to provide an operation image display device, an operation image display system, and an operation image display program to control the presentation of an operation image corresponding to the driver's likelihood of use of a function.

### BRIEF DESCRIPTION OF THE DRAWINGS

FIG. 1 is the configuration and the block diagram of an operation image display device according to a first aspect of the present invention.

FIG. 2 is a diagram illustrating a configuration of an operating unit according to the above-described first aspect; FIG. 2(a) is a front view, and FIG. 2(b) is a cross-sectional view taken along the line A-A of FIG. 2(a).

FIG. 3 is a diagram illustrating the relationship between the operating unit and an operation image according to the above-described first aspect.

FIG. 4 is a diagram illustrating the operation images according to the first aspect, a fifth aspect, and a fourteenth aspect.

FIG. 5 is a diagram illustrating selective displays of selection images according to the first aspect to a fourth aspect.

FIG. 6 is a diagram illustrating the movement of a layer of the selection image according to the fifth aspect and a sixth aspect.

FIG. 7 is a diagram illustrating the movement of a layer of the selection image according to the fifth aspect and a seventh aspect.

FIG. 8 is a diagram illustrating a selection range of the selection image according to a twelfth aspect.

FIG. 9 is an example in which the storage unit according to an eighth aspect and a ninth aspect stores a specific selection image, a specific layer, and a display position in association with each other and an example in which the storage unit according to a tenth aspect, an eleventh aspect, and a thirteenth aspect stores the number of selection images displayed and the maximum/minimum selection range of the selection image in association with each other.

FIG. 10 is a display example of giving notification that a control unit according to a fifteenth aspect has changed the presentation of the operation image.

FIG. 11 is a process diagram illustrating the input/output of information in the control unit according to the above-described first aspect.

FIG. 12 is a flowchart according to the above-described first aspect.

FIG. 13 is a flowchart according to the second aspect to the fourth aspect.

FIG. 14 is a flowchart according to the fifth aspect, the sixth aspect, and the eighth aspect to the eleventh aspect.

FIG. 15 is a flowchart according to the fifth aspect and the seventh aspect to the eleventh aspect.

FIG. 16 is a flowchart according to the twelfth aspect and the thirteenth aspect.

### MODE FOR CARRYING OUT THE INVENTION

A preferred embodiment described below is used for easy understanding of the present invention. Therefore, those skilled in the art should note that the present invention is not unduly limited to the embodiment described below.

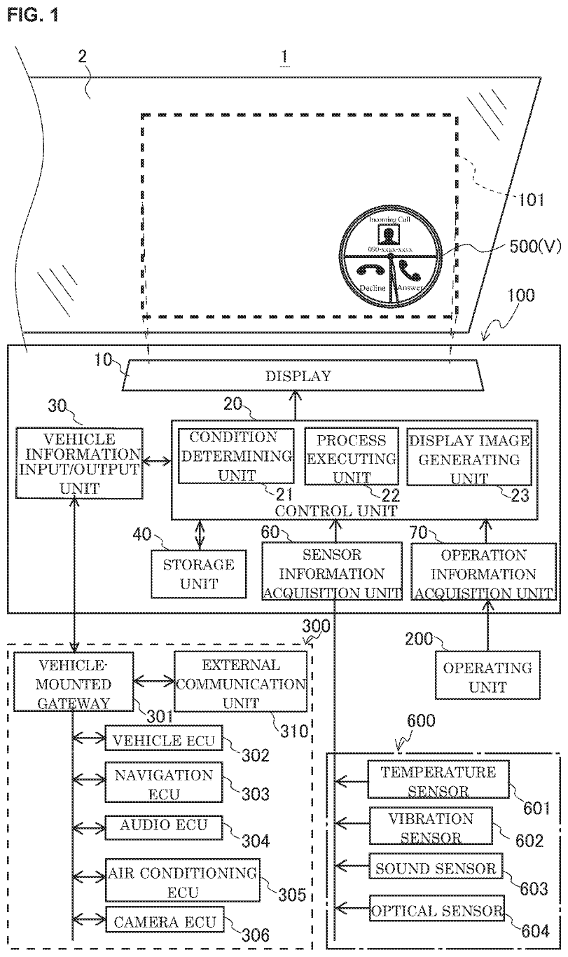

FIG. 1 illustrates the configuration and the block diagram of an operation image display device 100 according to a first aspect. The operation image display device 100 is installed in a vehicle 1 and includes a display 10, a control unit 20, a vehicle information input/output unit 30, a storage unit 40, a sensor information acquisition unit 60, and an operation information acquisition unit 70.

The display 10 forms what is called a windshield type head-up display (HUD) together with an undepicted optical system such as a concave mirror. The display light for representing an operation image 500 presented on the display 10 passes through the optical system such as the concave mirror, projects onto a windshield 2 of the vehicle 1, and then enters the eyes of the driver in the optical path changed due to the reflection by the windshield 2, or the like. The driver views the operation image 500 as a virtual image V in a display region 101 in front of the windshield 2.

The control unit 20 includes a circuitry, and the circuitry includes at least one semiconductor integrated circuit such as at least one processor (e.g., a central processing unit, CPU), at least one application specific integrated circuit (ASIC), and/or at least one field-programmable gate array (FPGA). At least one processor may read one or more commands from at least one computer-readable tangible recording medium to perform all or part of the functions of the operation image display device 100 illustrated in FIG. 1. The recording medium includes any type of magnetic medium such as a hard disk, any type of optical medium such as a compact disk (CD) or a digital versatile disk (DVD), any type of semiconductor memory such as a volatile memory, and a non-volatile memory. The volatile memory includes dynamic random-access memory (DRAM) and static random-access memory (SRAM), and the non-volatile memory includes read-only memory (ROM) and non-volatile random-access memory (NVRAM). The semiconductor memory is also a semiconductor circuit that is part of the circuitry together with at least one processor. The ASIC is an integrated circuit that is customized to execute all or some of the functions of the operation image display device 100 illustrated in FIG. 1, and the FPGA is an integrated circuit designed to execute all or part of the functions of the operation image display device 100 illustrated in FIG. 1 after manufacturing. The control unit 20 includes a condition determining unit 21, a process executing unit 22, and a display image generating unit 23, described later.

The vehicle information input/output unit 30 is a communication interface to acquire vehicle information via a vehicle-mounted network 300 and output it to the control unit 20. Furthermore, the vehicle information input/output unit 30 outputs the operation instruction information from the control unit 20 via the vehicle-mounted network 300 to an undepicted vehicle-mounted device coupled to an electronic control unit (ECU) and/or an undepicted external communication device coupled to an external communication unit 310.

The vehicle-mounted network 300 includes a controller area network bus (CAN), vehicle-mounted ethernet, and the like, and the ECUs (including, for example, a vehicle ECU 302, a navigation ECU 303, an audio ECU 304, an air conditioning ECU 305, and a camera ECU 306) and the external communication unit 310 are communicatively connected to one another via a vehicle-mounted gateway 301.

The vehicle-mounted gateway 301 has the functions to relay the transaction of information within the vehicle-mounted network 300, absorb the difference between communication protocols, and take measures for network security.

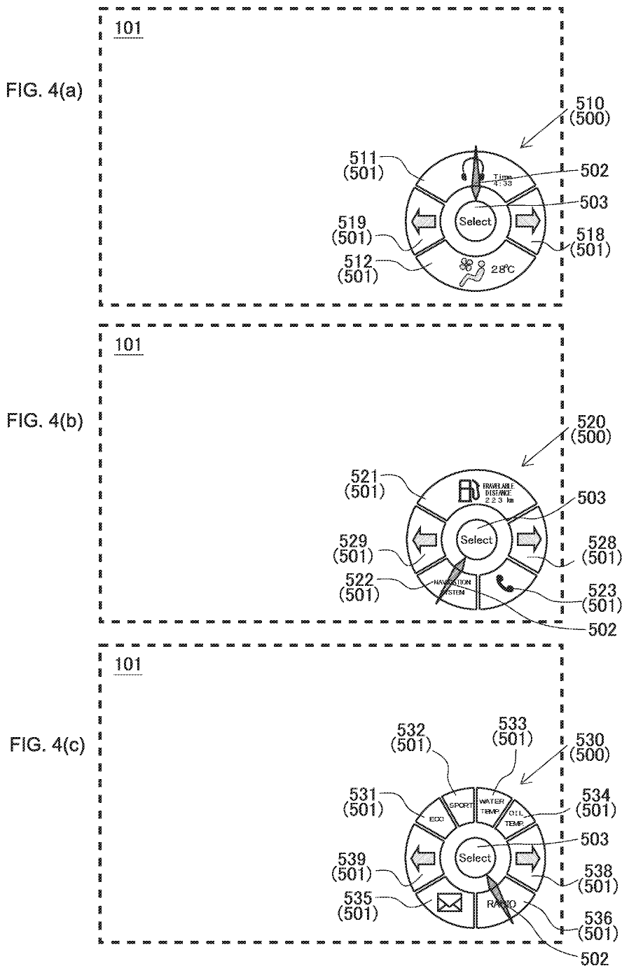

The vehicle ECU 302 may output the speed of the vehicle 1, the traveling mode (eco mode, sport mode), the remaining amount of traveling energy, the average fuel consumption, the travelable distance (the cruisable distance), the water temperature, the oil temperature, and the like, and based on them, the control unit 20 may display, within the operation image 500, for example, a selection image 501 (described below with reference to FIG. 4) displaying the traveling mode of the vehicle 1 and allowing a selection to change the traveling mode, the selection image 501 displaying the average fuel consumption, the cruisable distance (the travelable distance), the water temperature, the oil temperature, and the like, within the area and allowing a selection to display the further detailed information about the vehicle 1.

The navigation ECU 303 may output the current position information on the vehicle 1, the information about the direction of the subsequent branch road and the distance to the branch road, the facility information about a recommended stopover spot located near the route of the vehicle 1, and the information about, for example, the time loss in the case of the stopover, and based on them, the control unit 20 may display, within the operation image 500, for example the selection image 501 indicating the direction of the undepicted subsequent branch road and the distance to the branch road and allowing a selection to switch on/off the route guidance in a different display area and the selection image 501 allowing a selection to display the facility information regarding a recommended stopover spot or set a stopover spot.

The audio ECU 304 may output the information regarding recommended music, and the like and, based on them, the control unit 20 may display, within the operation image 500, for example the selection image 501 indicating the information about recommended music and allowing a selection to play the music.

The air conditioning ECU 305 may output the information about the current air conditioning status, and the like and, based on it, the control unit 20 may display, within the operation image 500, the selection image 501 indicating the information about the current air conditioning status and allowing a selection to display the detailed settings for the air conditioning status.

The camera ECU 306 may output the image data on the surroundings and the inside of the vehicle 1 captured by an undepicted stereo camera or monocular camera installed in the vehicle 1. Based on it, the control unit 20 may determine who the driver is and display the selection image 501 corresponding to the driver within the operation image 500. The camera ECU 306 may be further coupled to an undepicted advanced driver-assistance system (ADAS).

The external communication unit 310 is configured to use an undepicted external communication device such as a smartphone, a tablet, or a cloud server via a wired or wireless communication such as universal serial bus (USB), local area network (LAN), or Bluetooth (registered trademark), or a mobile communication such as 3G line or Long Term Evolution (LTE) line. The external communication unit 310 may output the incoming phone call status, the mail reception information, and the like and based on them, the control unit 20 may display, within the operation image 500, the selection image 501 indicating that there is an incoming phone call, indicating that there is a received mail, and allowing a selection so as to receive a phone call or read out the mail by voice.

The storage unit 40 includes a magnetic recording medium such as a non-volatile memory or a hard disk to store the operation history information on the driver. The storage unit 40 may store the maximum and/or the minimum selection range of the selection image 501 or the maximum and/or the minimum number of the selection images 501 displayed in one layer. Further, the storage unit 40 may store the specific selection image 501 in association with the display layer and the display position. The storage unit 40 may also serve as a recording medium for the control unit 20.

The sensor information acquisition unit 60 is a communication interface to output the sensor information acquired by a vehicle-mounted sensor 600 to the control unit 20.

The vehicle-mounted sensor 600 includes, for example, a temperature sensor 601, a vibration sensor 602, a sound sensor 603, and an optical sensor 604 to acquire at least the in-vehicle environment of the vehicle 1.

The operation information acquisition unit 70 is a communication interface to output the information on the operation performed by the driver through an operating unit 200 to the control unit 20.

### [Configuration of the Operating Unit 200]

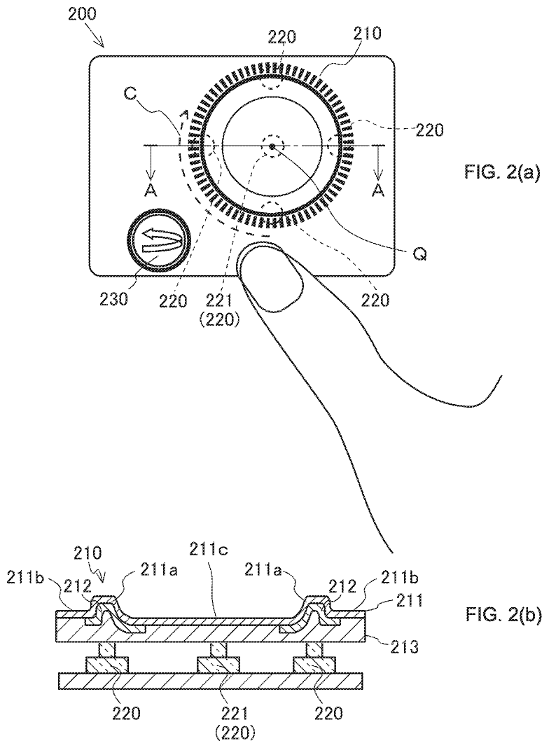

With reference to FIG. 2, the configuration of the operating unit 200 is described. FIG. 2(a) is a front view of the operating unit 200, and FIG. 2(b) is a cross-sectional view taken along the line A-A of FIG. 2(a). The operating unit 200 is provided on for example the steering wheel and is configured to include: an operation position detecting unit 210 that detects which part of it the driver's thumb is placed on (detects an operation position C) so as to give an instruction for the selection image 501 on the operation image 500 described later; a determination operation detecting unit 220 that is provided together with the operation position detecting unit 210 to determine the selection of the selection image 501 due to the pushing on the operation position detecting unit 210 with a finger; and a return detecting unit 230 that makes an input for the return due to the pushing with a finger.

The operating unit 200 includes a touch sensor that detects the position (the operation position C) of the operation surface touched by the driver's thumb, or the like, and includes a surface cover 211, a sensor sheet 212, and a spacer 213 as illustrated in FIG. 2(b) to detect the operation position C on the operation surface touched by the thumb, or the like, under the control of the control unit 20 when the driver performs the operation (hereinafter referred to as a touch operation) to touch the operation surface with the thumb, or the like, or the operation (hereinafter referred to as a gesture operation) to trace along a predetermined trajectory as if as a drawing and prompt the selection of any of the selection images 501 on the operation image 500 displayed on the display 10.

The surface cover 211 is made of a light-shielding insulating material such as a synthetic resin to have a sheet-like shape and includes: a recessed and protruding portion 211a in which a three-dimensional recessed and protruding configuration is continuously formed in a circle with a center point Q as a center; a flat portion 211b that is relatively flat and is provided on the circumferential edge of the recessed and protruding portion 211a; and a flat central portion 211c that is positioned inside the recessed and protruding portion 211a. The three-dimensional recessed and protruding configuration of the recessed and protruding portion 211a is formed such that a large number of protruding portions that are long in the direction toward the center point Q and is short in the circumferential direction are provided along the trajectory in the circumferential direction, and the driver touches and recognizes the recessed and protruding portion 211a in the longitudinal direction (the direction toward the center point Q) with a finger so as to recognize the approximate position of the finger on the operation position detecting unit 210 and therefore perform a touch typing operation that is an operation on the operating unit 200 without looking at the operating unit 200. Furthermore, even without the three-dimensional recessed and protruding configuration, if the driver traces the trajectory around the predetermined center point Q to move the position of the hand, the driver could guess the approximate position of the hand on the trajectory based on the trajectory of the moved hand so as to perform a touch typing operation that is an operation on the operating unit 200 without looking at the operating unit 200.

The sensor sheet 212 is a sensor sheet that is provided in a circle around the center point Q on the back surface side of the surface cover 211 corresponding to at least the recessed and protruding portion 211a to detect the operation position C of the driver's finger and output the position information signal regarding the operation position C of the driver's finger to the control unit 20. The sensor sheet 212 is integrally formed with the surface cover 211 through drawing processing to be formed in the same shape as that of the surface cover 211 (See FIG. 2(b)). This integral molding allows the surface cover 211 and the sensor sheet 212 to become a single sheet, and the bend portion of the single sheet forms a stepped form of the recessed and protruding portion 211a. Furthermore, this integral molding allows the back surface of the surface cover 211 to be in contact with the front surface of the sensor sheet 212. Thus, a detecting unit of the sensor sheet 212 is disposed corresponding to the stepped form of the surface cover 211. As the detecting unit of the sensor sheet 212 is thus disposed corresponding to the stepped form of the surface cover 211, the control unit 20 may detect the position of the driver's finger even based on the operation performed on the operation surface having a stepped form such as the recessed and protruding portion 211a.

The spacer 213 is a member that is provided on the back surface side of the sensor sheet 212 and is formed in accordance with the shapes of the surface cover 211 and the sensor sheet 212, which are integrally molded, to maintain the shapes of them when a pressure is applied from the front side of the surface cover 211 due to the driver's operation.

The determination operation detecting units 220 are provided on the back surface side of the operation position detecting unit 210, are electrically connected to the control unit 20, and are pushed so as to output a determination signal to the control unit 20 when the driver performs the operation (hereafter referred to as a pushing operation) to push the operation surface (the recessed and protruding portion 211a) of the operation position detecting unit 210. The control unit 20 selects and determines the selection image 501 within the operation image 500 based on the determination signal from the determination operation detecting units 220 and switches the presentation of the operation image 500 corresponding to the selected selection image 501.

Further, a central determination operating unit 221 is the determination operation detecting unit 220 provided in the central portion on the back surface side of the operation position detecting unit 210. As the sensor sheet 212 is not provided in the central portion 211c of the operation surface of the operation position detecting unit 210, the position of the driver's finger is not detected even when the pushing operation is performed on the central determination operating unit 221, and the determination signal may be exclusively output to the control unit 20.

The return detecting unit 230 is a switch that is located apart from the operation position detecting unit 210 and the determination operation detecting unit 220 and, when the driver performs the pushing operation on the operation surface of the return detecting unit 230, outputs a return signal to the control unit 20. The control unit 20 returns the presentation of the operation image 500 to the presentation before switching based on the return signal from the return detecting unit 230.

### [Relationship Between the Operating Unit 200 and the Operation Image 500]

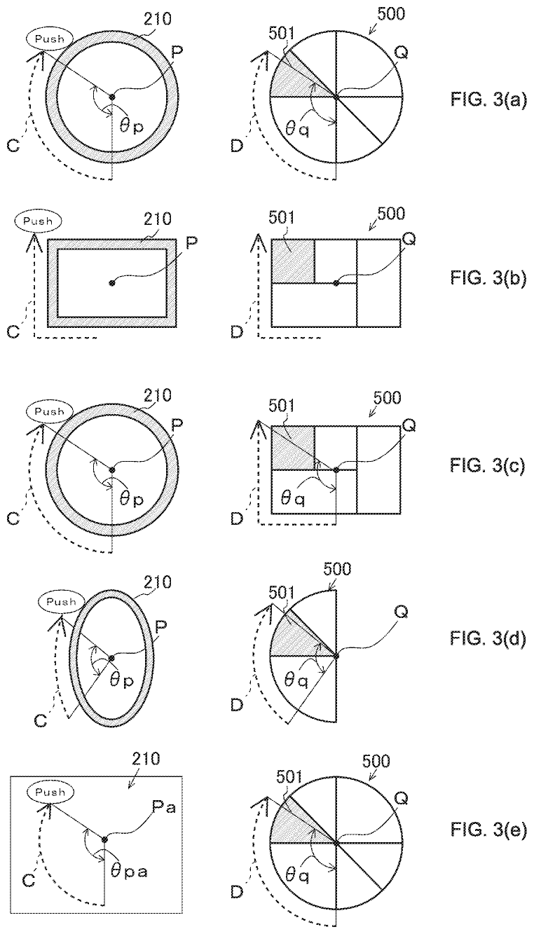

FIG. 3 is a diagram illustrating the relationship between the operating unit 200 and the operation image 500; the left figure of FIGS. 3(a), (b), (c), (d), and (e) illustrates an example of the operation position detecting unit 210 that detects the operation position C on the operating unit 200, and the right figure illustrates the state of the operation image 500 when it is operated by the operation position detecting unit 210 in the left figure.

FIG. 3(a) illustrates a case where the shape of the trajectory on which the operation position detecting unit 210 may detect the operation position C and the shape of the trajectory on which the selection images 501 are disposed are the identical circle. When the driver performs a gesture operation to move the operation position C in the circular operation position detecting unit 210 illustrated in the left figure, an instruction position D is moved based on the operation position C in the selection images 501 disposed with the circular trajectory illustrated in the right figure, and the selection image 501 corresponding to the push operation “Push” on the determination operation detecting unit 220 is selected. The control unit 20 moves the instruction position D such that a relative angle θq of the instruction position D around the center point Q with the trajectory of the disposed selection images 501 substantially coincides with a relative angle θp of the operation position C around a center point P with the trajectory on which the operation position detecting unit 210 may detect the operation position C.

FIG. 3(b) illustrates a case where the shape of the trajectory on which the operation position detecting unit 210 may detect the operation position C and the shape of the trajectory on which the selection images 501 are disposed are the identical rectangle. When the driver performs a gesture operation to move the operation position C in the rectangular operation position detecting unit 210 illustrated in the left figure, the instruction position D moves based on the operation position C on the selection images 501 disposed with the rectangular trajectory illustrated in the right figure, and the corresponding selection image 501 is selectively determined corresponding to the pushing operation “Push” on the determination operation detecting unit 220.

FIG. 3(c) illustrates a case where the shape of the trajectory on which the operation position detecting unit 210 may detect the operation position C is a circle and the shape of the trajectory on which the selection images 501 are disposed is different, a rectangle. The control unit 20 moves the instruction position D such that the relative angle θq of the instruction position D around the center point Q with the trajectory of the disposed selection images 501 substantially coincides with the relative angle θp of the operation position C around the center point P with the trajectory on which the operation position detecting unit 210 may detect the operation position C. Specifically, for example, when the shape (circle) of the trajectory on which the operation position detecting unit 210 may detect the operation position C is different from the shape (rectangle) of the trajectory on which the selection images 501 are disposed and when the driver performs a gesture operation to move the operation position C in the operation position detecting unit 210 illustrated in FIG. 3(c), the instruction position D is moved (FIG. 3(d)) so as to have the relative angle θq corresponding to the relative angle θp of the operation position C around the center point P, and the corresponding selection image 501 is selectively determined in accordance with the pushing operation “Push” of the determination operation detecting unit 220.

Furthermore, the shape of the trajectory on which the operation position detecting unit 210 may detect the operation position C and the shape of the trajectory on which the selection images 501 are disposed may be a closed figure having no edge points and an open figure having an edge point. In FIG. 3(d), the trajectory on which the operation position detecting unit 210 may detect the operation position C is an oval figure that is a closed figure, the trajectory on which the selection images 501 are disposed is a semicircular figure that is an open figure, the instruction position D is moved so as to have the relative angle θq corresponding to the relative angle θp of the operation position C around the center point P (FIG. 3(d)) when the driver performs a gesture operation to move the operation position C in the operation position detecting unit 210, and the corresponding selection image 501 is selectively determined in accordance with the pushing operation “Push” on the determination operation detecting unit 220.

Further, the operation position detecting unit 210 does not need to be able to exclusively detect the operation position C on a specific trajectory. In FIG. 3(e), the operation position detecting unit 210 is provided so as to detect the operation position C of the driver on a two-dimensional surface such as a touch pad and, when the driver performs a gesture operation with the shape of a specific trajectory for the operation position C on the operation position detecting unit 210, the control unit 20 may determine a center point Pa of the trajectory from the operation position C of the operation position detecting unit 210 in accordance with the movement of the operation position C and a relative angle θpa of the operation position C with respect to the center point Pa and perform the control to move the instruction position D so as to have the relative angle θq corresponding to the relative angle θpa of the operation position C.

Furthermore, in the above-described operating unit 200, the determination operation detecting units 220 are provided on the back surface side of the operation position detecting unit 210, are electrically connected to the control unit 20, and are pushed so as to output a determination signal to the control unit 20 when the driver performs a pushing operation on the operation surface (the recessed and protruding portion 211a) of the operation position detecting unit 210; however, this is not a limitation as long as an input interface outputs a determination signal after the driver performs a determination operation. The operation position detecting unit 210 may be operated with the driver's thumb, and the determination operation detecting unit 220 may be provided at a position apart from the operation position detecting unit 210 so as to be operated with a different finger. A signal for the operation position C may be output based on the position of the driver's hand due to a gesture operation in the operation position detecting unit 210, and a determination signal may be output when the driver moves the hand away from the operation position detecting unit 210 at the predetermined position for the operation position C.

Moreover, a determination signal may be output in accordance with a double tap operation that is two quick taps on the operation position detecting unit 210 at the specific operation position C.

### [Display Mode of the Operation Image 500]

FIG. 4 is a diagram illustrating the operation images 500 according to the first aspect, a fifth aspect, and a fourteenth aspect. FIG. 4(a) illustrates an operation image 510 in a first layer, FIG. 4(b) illustrates an operation image 520 in a second layer, and FIG. 4(c) illustrates an operation image 530 in a third layer. Although FIG. 4 illustrates the operation images 500 in three layers, there may be four or more layers, or there may be one or two layers. On the operation image 500, the selection images 501 are arranged along the trajectory (circular trajectory), and the selection image 501 may be selectively displayed and selectively determined in accordance with the operation on the operating unit 200. A selection display image 502 is the image selectively displaying (pointing) the specific selection image 501 among the selection images 501. A selection determination image 503 is displayed to present to the driver that the selection image 501 selectively displayed by the selection display image 502 is to be selectively determined in response to the pushing operation on the central determination operating unit 221.

The operation image 510 in FIG. 4(a) displays the selection display image 502, the selection determination image 503, an audio selection image 511, an air conditioning selection image 512, a subsequent layer selection image 518, and a previous layer selection image 519.

The audio selection image 511 and the air conditioning selection image 512 are selectively determined in response to the pushing operation on the determination operation detecting unit 220 while they are selectively displayed with the selection display image 502.

The subsequent layer selection image 518 is selectively determined in response to the pushing operation on the determination operation detecting unit 220 while it is selectively displayed with the selection display image 502 so that the operation image 520 in the second layer is displayed in place of the operation image 510 in the first layer.

The previous layer selection image 519 is selectively determined in response to the pushing operation on the determination operation detecting unit 220 while it is selectively displayed with the selection display image 502 so that the operation image 530 in the lowest layer according to the present aspect, i.e., a third layer, is displayed in place of the operation image 510 in the first layer. Furthermore, instead of displaying the previous layer selection image 519 in the first layer, the selection ranges of the audio selection image 511 and the air conditioning selection image 512 may be enlarged, or the other selection image 501 may be displayed.

The operation image 520 in FIG. 4(b) displays a cruisable distance selection image 521, a navigation system selection image 522, a phone selection image 523, a subsequent layer selection image 528, and a previous layer selection image 529.

The cruisable distance selection image 521, the navigation system selection image 522, and the phone selection image 523 are selectively determined in response to the pushing operation on the determination operation detecting unit 220 while they are selectively displayed with the selection display image 502.

The subsequent layer selection image 528 is selectively determined in response to the pushing operation on the determination operation detecting unit 220 while it is selectively displayed with the selection display image 502 so that the operation image 530 in the third layer is displayed in place of the operation image 520 in the second layer.

The previous layer selection image 529 is selectively determined in response to the pushing operation on the determination operation detecting unit 220 while it is selectively displayed with the selection display image 502 so that the operation image 510 in the first layer is displayed in place of the operation image 520 in the second layer.

The operation image 530 in FIG. 4(c) displays an eco-mode selection image 531, a sport-mode selection image 532, an oil temperature selection image 533, a water temperature selection image 534, a mail selection image 535, a radio selection image 536, a subsequent layer selection image 538, and a previous layer selection image 539.

The eco-mode selection image 531, the sport-mode selection image 532, the oil temperature selection image 533, the water temperature selection image 534, the mail selection image 535, and the radio selection image 536 are selectively determined in response to the pushing operation on the determination operation detecting unit 220 while it is selectively displayed with the selection display image 502.

The subsequent layer selection image 538 is selectively determined in response to the pushing operation on the determination operation detecting unit 220 while it is selectively displayed with the selection display image 502 so that the operation image 510 in the highest layer according to the present embodiment, i.e., the first layer, is displayed in place of the operation image 530 in the third layer. Furthermore, instead of displaying the previous layer selection image 539 in the third layer, the selection ranges of the eco-mode selection image 531, the sport-mode selection image 532, the oil temperature selection image 533, the water temperature selection image 534, the mail selection image 535, and the radio selection image 536 may be enlarged, or the other selection image 501 may be displayed.

The previous layer selection image 539 is selectively determined in response to the pushing operation on the determination operation detecting unit 220 while it is selectively displayed with the selection display image 502 so that the operation image 520 in the second layer is displayed in place of the operation image 530 in the third layer.

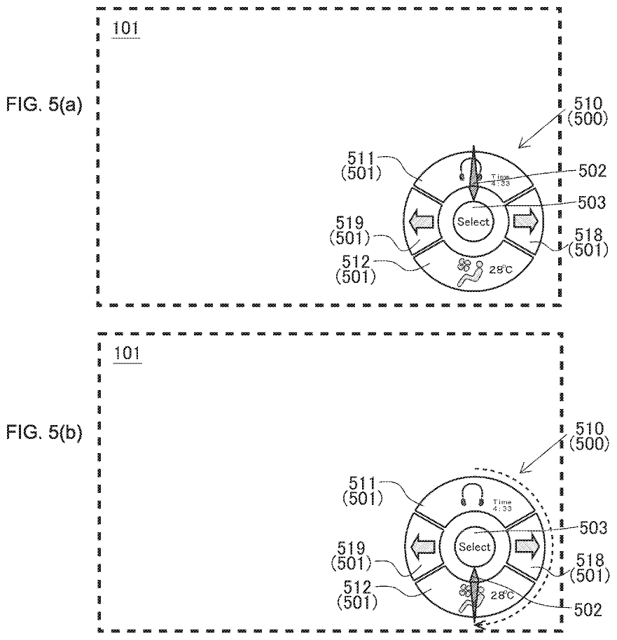

A reference is made to FIG. 5. FIG. 5 is a diagram illustrating selective displays of the selection images 501 according to the first aspect to a fourth aspect. FIG. 5(a) illustrates the operation image 510 before the control unit 20 selectively displays the selection image 501 (the air conditioning selection image 512), and FIG. 5(b) illustrates the operation image 510 after the control unit 20 selectively displays the selection image 501 (the air conditioning selection image 512).

The control unit 20 determines that there is a high likelihood of use of the air conditioning function when it is determined that the temperature acquired by the temperature sensor 601 is high. The control unit 20 moves the selection display image 502 to selectively display the air conditioning selection image 512. Furthermore, the control unit 20 may conduct search as to whether there is a situation similar to the current vehicle information on the vehicle 1 or the sensor information based on the operation history information and selectively display the selection image 501 that is selectively determined in the past similar situation. The driver may perform a pushing operation on the determination operation detecting unit 220 to selectively determine the selection image 501 (e.g., the air conditioning selection image 512) that is selectively displayed.

Alternatively, the driver performs a gesture operation to move the operation position C on the operation position detecting unit 210 so as to selectively display the different selection image 501 (e.g., the audio selection image 511) and selectively determine the different selection image 501 in response to the pushing operation on the determination operation detecting unit 220.

The control unit 20 preferably moves the selection display image 502 when no operation is performed in the operating unit 200 for a period of time more than a threshold, and the threshold may be adjusted in accordance with at least one of the vehicle information, the sensor information, and the operation history information and/or the time it takes before the driver performs an operation. For example, a high threshold is set when the vehicle 1 is traveling at a high speed, a low threshold is set when the temperature inside the vehicle 1 is high, or a high threshold is set when it takes a long time from the start of the operation on the operating unit 200 by the driver until the pushing operation on the determination operation detecting unit 220. This prevents the driver from moving the selection display image 502 while operating the operating unit 200 and allows the threshold to be adjusted in accordance with the condition of the vehicle 1 and the characteristics of the driver.

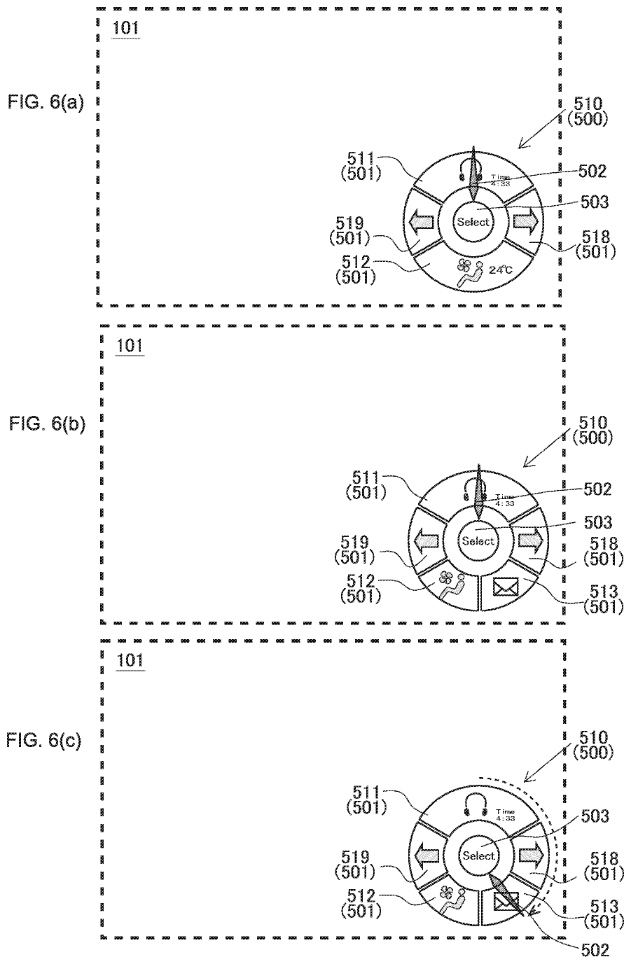

A reference is made to FIG. 6. FIG. 6 is a diagram illustrating the movement of a layer of the selection image 501 according to the fifth aspect and a sixth aspect. According to the present aspect, the operation image 500 includes two or more layers. FIG. 6(a) illustrates the operation image 510 before the control unit 20 moves the layer of the selection image 501 (a mail selection image 513), FIG. 6(b) illustrates the operation image 510 after the control unit 20 moves the layer of the selection image 501 (the mail selection image 513), and FIG. 6(c) illustrates the operation image 510 in which the selection image 501 (the mail selection image 513) is further selectively displayed after the control unit 20 moves the layer.

The control unit 20 determines that there is a high likelihood of use of the mail function when the control unit 20 is notified by the external communication unit 310 that a mail has been received. The control unit 20 moves the mail selection image in the third layer to the first layer to display the mail selection image 513 on the operation image 510. The control unit 20 may further move the selection display image 502 to selectively display the mail selection image 513. The driver may perform a pushing operation on the determination operation detecting unit 220 to selectively determine the mail selection image 513.

Furthermore, the movement of a layer of the selection image 501 may be executed between for example the second layer and the third layer as appropriate as well as between the layers displayed in the display region 101.

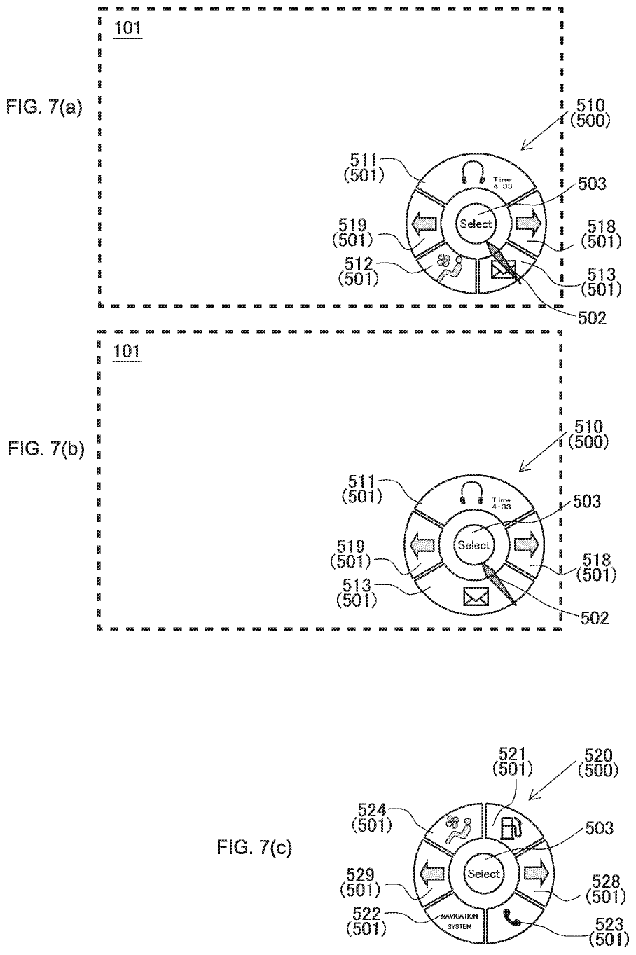

A reference is made to FIG. 7. FIG. 7 is a diagram illustrating the movement of a layer of the selection image 501 according to the fifth aspect and a seventh aspect. According to the present aspect, the operation image 500 includes two or more layers. FIG. 7(a) illustrates the operation image 510 before the control unit 20 moves the layer of the selection image 501 (the air conditioning selection image 512), FIG. 7(b) illustrates the operation image 510 after the control unit 20 moves the layer of the selection image 501 (the air conditioning selection image 512), and FIG. 7(c) illustrates the operation image 520 in which the control unit 20 allocates the selection image 501 (the air conditioning selection image 512) as a selection image 524 (501) in the second layer and which is not displayed in the display region 110.

The control unit 20 determines that there is a low likelihood of use of the air conditioning function when it is determined that the temperature acquired by the temperature sensor 601 is an appropriate temperature or when the air conditioning function remains off for a certain period of time. The control unit 20 moves the air conditioning selection image 512 in the first layer to the second layer and does not display the air conditioning selection image 512 on the operation image 510.

Furthermore, the layer movement may be executed between for example the second layer and the third layer as appropriate as well as between the layers displayed in the display region 101.

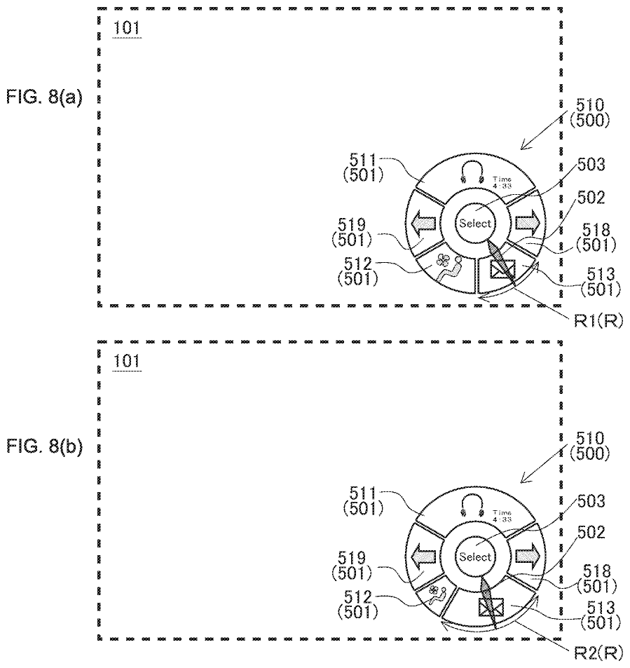

A reference is made to FIG. 8. FIG. 8 is a diagram illustrating a selection range of the selection image 501 according to a twelfth aspect. FIG. 8(a) is the operation image 510 (500) before the selection range of the selection image 501 (the mail selection image 513) is enlarged, and FIG. 8(b) is the operation image 510 (500) after the selection range of the selection image 501 (the mail selection image 513) is enlarged.

When it is determined that the mail function is frequently used based on the operation history information, the control unit 20 enlarges a selection range R of the mail selection image 513 from R1 to R2. Specifically, the larger the selection range R of the selection image 501 is, the wider the area where the selection image 501 is selectively displayable on the operation position detecting unit 210 is set, whereby it is easy to select the frequently used selection image 501.

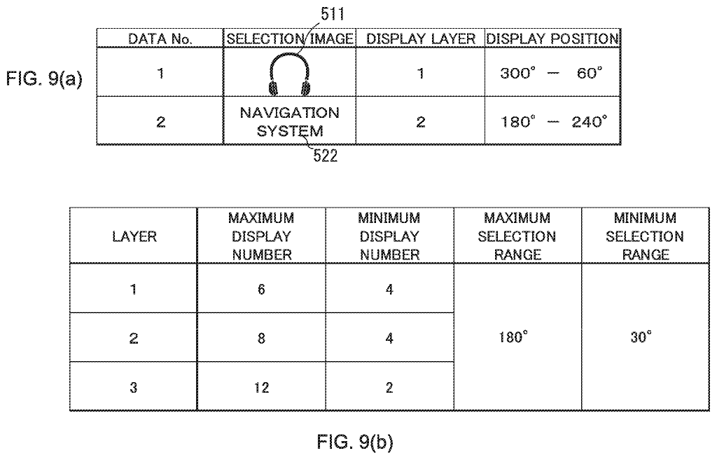

A reference is made to FIG. 9. FIG. 9(a) is an example in which the storage unit 40 according to an eighth aspect and a ninth aspect stores a specific selection image, a specific layer, and a display position in association with each other, and FIG. 9(b) is an example in which the storage unit 40 according to a tenth aspect, an eleventh aspect, and a thirteenth aspect stores the number of selection images displayed and the maximum/minimum selection range of the selection image 501 in association with each other.

In FIG. 9(a), data No. 1 indicates that the audio selection image 511 corresponding to the audio function is displayed in the first layer from 300° (−60°) to 60°, and data No. 2 indicates that the navigation system selection image 522 corresponding to the navigation function is displayed in the second layer from 180° to 240°. This allows the driver to designate the layer and the position of the selection image 501 of the function desired by the driver to be displayed, whereby it is possible to shorten the operating time of the operating unit 200. Furthermore, the display position may be designated by using the coordinates in the display region 101.

FIG. 9(b) indicates that the maximum number of the selection images 501 displayed in the first layer is six and the minimum number thereof is four, the maximum number of the selection images 501 displayed in the second layer is eight and the minimum number thereof is four, and the maximum number of the selection images 501 displayed in the third layer is twelve and the minimum number thereof is two. Furthermore, it is indicated that the maximum selection range of the selection image 501 is 180° and the minimum selection range is 30°. Moreover, the maximum and/or minimum selection range may be designated by using a percentage of the operation image 500.

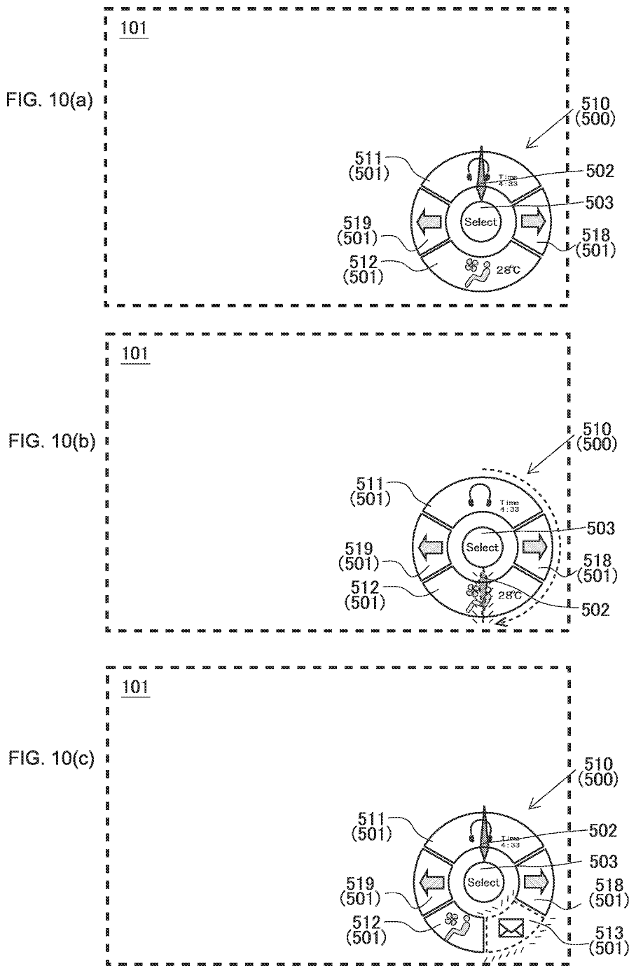

A reference is made to FIG. 10. FIG. 10(a) illustrates a display example before the control unit 20 changes the presentation of the operation image 510 (500), FIG. 10(b) illustrates a display example of the operation image 510 (500) when the control unit 20 has moved the selection display image 502, and FIG. 10(c) illustrates a display example of the operation image 510 (500) when the control unit 20 has moved the mail selection image 513 to the first layer.

When the presentation of the operation image 500 is changed, the control unit 20 highlights the changed part, for example, makes the color of the image at the part darker or flashes the part so as to give notification to the driver.

Furthermore, when the presentation of the operation image 500 is changed, the control unit 20 may send operation instruction information to the audio ECU 304 and give notification to the driver by sound.

### [Input/Output of Information in the Control Unit 20]

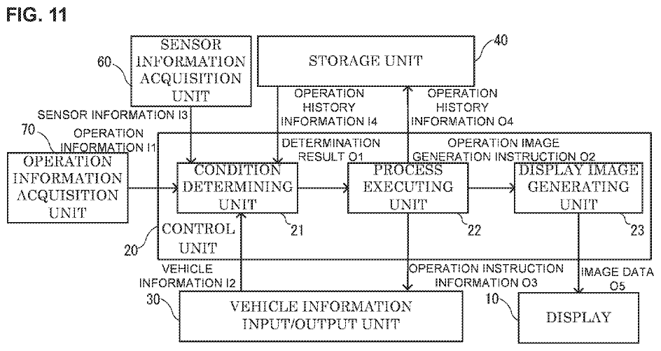

A reference is made to FIG. 11. FIG. 11 is a process diagram illustrating the input/output of information in the control unit 20.

Based on at least one of vehicle information I2, sensor information I3, and operation history information I4, the condition determining unit 21 determines whether the acquired information satisfies a predetermined condition or a predetermined combination of acquired pieces of information is satisfied and then outputs a determination result O1. Furthermore, as the operation history information I4, the latest operation history information may be exclusively acquired, or a plurality of pieces of operation history information may be acquired.

Moreover, the condition determining unit 21 determines whether a gesture operation for moving the operation position C has been performed based on the operation information I1 or a determination signal has been output and then outputs the determination result O1.

The process executing unit 22 switches an operation image generation instruction O2 “in the case where the condition is satisfied (in the case of Yes)” and “in the case where the condition is not satisfied (in the case of No)” based on the determination result O1.

Furthermore, when the execution of a function is instructed by the determination signal, the process executing unit 22 outputs operation instruction information O3 to the vehicle-mounted network 300 via the vehicle information input/output unit 30 and also stores, in the storage unit 40, operation history information O4 in which the vehicle information I2 and/or the sensor information I3 is associated with the operation information I1.

The display image generating unit 23 reads the available selection image 501 from for example the prepared selection images 501 in the storage unit 40 and incorporates necessary information through image synthesis to generate the operation image 500 including the selection images 501. This is not a limitation, however, and the operation image 500 may be generated by allocating a plurality of items (synthesizing item images) in accordance with the alignment previously stored in the storage unit 40 or the alignment defined by a program stored in the storage unit 40 or the operation image 500 may be generated by rendering. For the generated operation image 500, the data format is arranged, the information necessary for display is added, and the consequently obtained image data O5 is sent to the display 10.

The display image generating unit 23 may add information such as the speed of the vehicle 1, the remaining amount of traveling energy, or the like, acquired from the vehicle information to the image data O5 and simultaneously display the operation image 500 and the vehicle information on the vehicle 1.

### [Flowchart According to the Present Aspect]

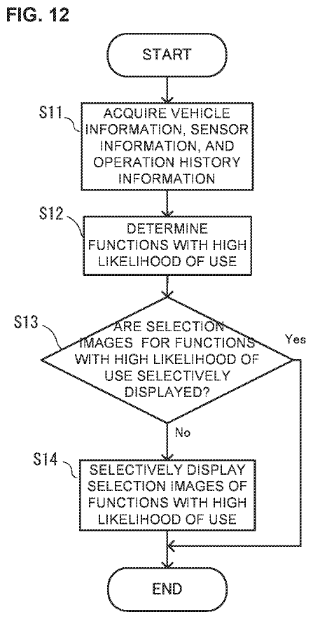

A reference is made to FIG. 12. FIG. 12 is a flowchart according to the first aspect.

At Step S11, the control unit 20 acquires vehicle information, sensor information, and operation history information.

At Step S12, the control unit 20 determines a function with high likelihood of use based on at least one of the vehicle information, the sensor information, and the operation history information.

At Step S13, the control unit 20 determines whether the selection image 501 corresponding to the function with high likelihood of use is selectively displayed. The process proceeds to Step S14 “when the selection image 501 corresponding to the function with high likelihood of use is not selectively displayed (in the case of No)”, and the process ends “when the selection image 501 corresponding to the function with high likelihood of use is selectively displayed (in the case of Yes)”.

At Step S14, the control unit 20 generates the operation image 500 so that the selection image 501 corresponding to the function with high likelihood of use is selectively displayed.

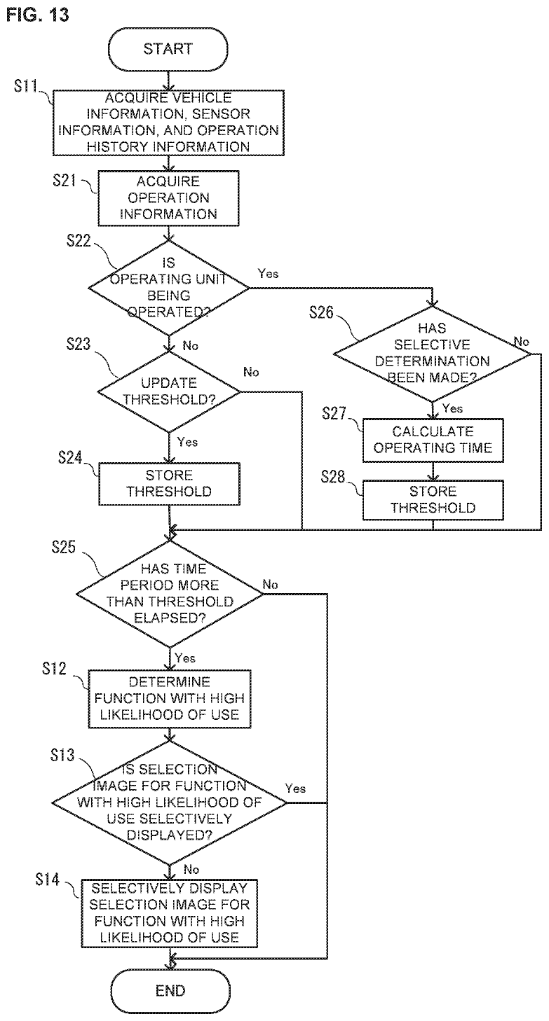

A reference is made to FIG. 13. FIG. 13 is a flowchart according to the second aspect to the fourth aspect.

At Step S11, the control unit 20 acquires vehicle information, sensor information, and operation history information.

At Step S21, the control unit 20 acquires operation information.

At Step S22, the control unit 20 determines whether the operating unit 200 is being operated based on the operation information. The process proceeds to Step S23 “when the operating unit 200 is not being operated (in the case of No)”, and the process proceeds to Step S26 “when the operating unit 200 is being operated (in the case of Yes)”.

At Step S23, the control unit 20 determines whether the threshold needs to be changed based on the vehicle information, the sensor information, and the operation history information. The process proceeds to Step S24 “when the threshold needs to be changed (in the case of Yes)”, and the process proceeds to Step S25 “when the threshold does not need to be changed (in the case of No)”.

At Step S24, the control unit 20 changes the threshold based on at least one of vehicle information, sensor information, and operation history information and stores it in the storage unit 40.

At Step S25, the control unit 20 determines whether the time period more than a threshold has elapsed after the operation on the operating unit 200 based on the operation information and the operation history information. The process proceeds to Step S12 “when the time period more than the threshold has elapsed (in the case of Yes)”, and the process ends “when the time period more than the threshold has not elapsed (in the case of No)”.

At Step S12, the control unit 20 determines a function with high likelihood of use based on at least one of the vehicle information, the sensor information, and the operation history information.

At Step S13, the control unit 20 determines whether the selection image 501 corresponding to the function with high likelihood of use is selectively displayed. The process proceeds to Step S14 “when the selection image 501 corresponding to the function with high likelihood of use is not selectively displayed (in the case of No)”, and the process ends “when the selection image 501 corresponding to the function with high likelihood of use is selectively displayed (in the case of Yes)”.

At Step S14, the control unit 20 generates the operation image 500 so that the selection image 501 corresponding to the function with high likelihood of use is selectively displayed.

At Step S26, the control unit 20 determines whether the selection image 501 has been selectively determined based on the operation information. The process proceeds to Step S27 “when the selection image 501 has been selectively determined (in the case of Yes)”, and the process proceeds to Step S25 “when the selection image 501 has not been selectively determined (in the case of No)”.

At Step S27, the control unit 20 calculates the operating time from the operation information and the operation history information.

At Step S28, the control unit 20 changes the threshold based on the operating time and stores it in the storage unit 40.

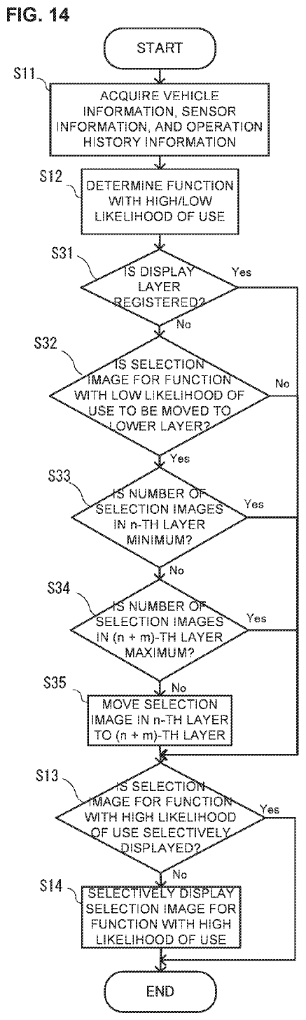

A reference is made to FIG. 14. It is a flowchart according to the fifth aspect, the sixth aspect, and the eighth aspect to the eleventh aspect.

At Step S11, the control unit 20 acquires vehicle information, sensor information, and operation history information.

At Step S12, the control unit 20 determines a function with high likelihood of use and a function with low likelihood of use based on at least one of the vehicle information, the sensor information, and the operation history information.

At Step S31, the control unit 20 determines whether the display layer of the selection image 501 corresponding to the function with low likelihood of use is registered in the storage unit 40. The process proceeds to Step S32 “when the display layer of the selection image 501 is not registered (in the case of No)”, and the process proceeds to Step S13 “when the display layer of the selection image 501 is registered (in the case of Yes)”.

At Step S32, the control unit 20 determines whether the selection image 501 corresponding to the function with low likelihood of use is to be moved to a lower layer based on at least one of the vehicle information, the sensor information, and the operation history information. The process proceeds to Step S33 “when the layer of the selection image 501 is to be moved (in the case of Yes), and the process proceeds to Step S13” when the layer of the selection image 501 is not to be moved (in the case of No).

At Step S33, the control unit 20 determines whether the number of the selection images 501 in the n-th layer is the minimum. The process proceeds to Step S34 “when the number of the selection images 501 in the n-th layer is not the minimum (in the case of No)”, and the process proceeds to Step S13 “when the number of the selection images 501 in the n-th layer is the minimum (in the case of Yes)”.

At Step S34, the control unit 20 determines whether the number of the selection images 501 in the (n+m)-th layer is the maximum. The process proceeds to Step S35 “when the number of the selection images 501 in the (n+m)-th layer is not the maximum (in the case of No), and the process proceeds to Step S13 “when the number of the selection images 501 in the (n+m)-th layer is the maximum (in the case of Yes)”.

At Step S35, the control unit 20 moves the selection image 501 corresponding to the function with low likelihood of use in the n-th layer to the (n+m)-th layer.

At Step S13, the control unit 20 determines whether the selection image 501 corresponding to the function with high likelihood of use is selectively displayed. The process proceeds to Step S14 “when the selection image 501 corresponding to the function with high likelihood of use is not selectively displayed (in the case of No)”, and the process ends “when the selection image 501 corresponding to the function with high likelihood of use is selectively displayed (in the case of Yes)”.

At Step S14, the control unit 20 generates the operation image 500 so that the selection image 501 corresponding to the function with high likelihood of use is selectively displayed.

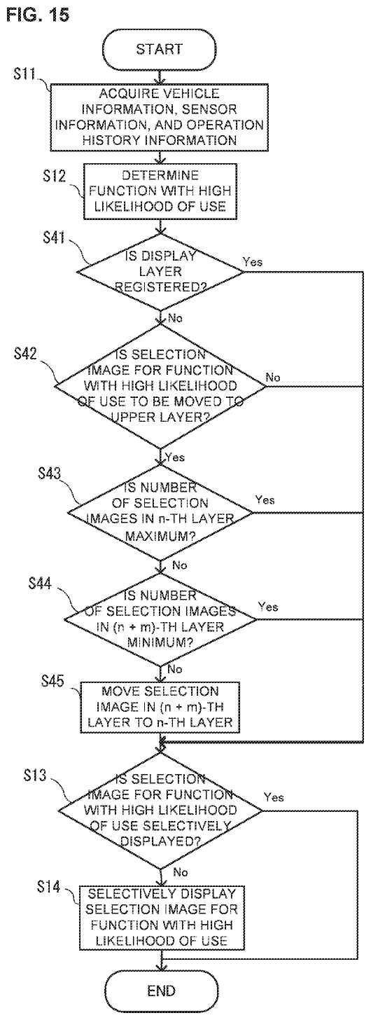

A reference is made to FIG. 15. It is a flowchart according to the fifth aspect and the seventh aspect to the eleventh aspect.

At Step S11, the control unit 20 acquires vehicle information, sensor information, and operation history information.

At Step S12, the control unit 20 determines a function with high likelihood of use based on at least one of the vehicle information, the sensor information, and the operation history information.

At Step S41, the control unit 20 determines whether the display layer of the selection image 501 corresponding to the function with high likelihood of use is registered in the storage unit 40. The process proceeds to Step S42 “when the display layer of the selection image 501 is not registered (in the case of No)”, and the process proceeds to Step S13 “when the display layer of the selection image 501 is registered (in the case of Yes)”.

At Step S42, the control unit 20 determines whether the selection image 501 corresponding to the function with high likelihood of use is to be moved to an upper layer based on at least one of the vehicle information, the sensor information, and the operation history information. The process proceeds to Step S43 “when the layer of the selection image 501 is to be moved (in the case of Yes), and the process proceeds to Step S13” when the layer of the selection image 501 is not to be moved (in the case of No).

At Step S43, the control unit 20 determines whether the number of the selection images 501 in the n-th layer is the maximum. The process proceeds to Step S44 “when the number of the selection images 501 in the n-th layer is not the maximum (in the case of No), and the process proceeds to Step S13 “when the number of the selection images 501 in the n-th layer is the maximum (in the case of Yes)”.

At Step S44, the control unit 20 determines whether the number of the selection images 501 in the (n+m)-th layer is the minimum. The process proceeds to Step S45 “when the number of the selection images 501 in the (n+m)-th layer is not the minimum (in the case of No)”, and the process proceeds to Step S13 “when the number of the selection images 501 in the (n+m)-th layer is the minimum (in the case of Yes)”.

At Step S45, the control unit 20 moves the selection image 501 corresponding to the function with high likelihood of use in the (n+m)-th layer to the n-th layer.

At Step S13, the control unit 20 determines whether the selection image 501 corresponding to the function with high likelihood of use is selectively displayed. The process proceeds to Step S14 “when the selection image 501 corresponding to the function with high likelihood of use is not selectively displayed (in the case of No)”, and the process ends “when the selection image 501 corresponding to the function with high likelihood of use is selectively displayed (in the case of Yes)”.

At Step S14, the control unit 20 generates the operation image 500 so that the selection image 501 corresponding to the function with high likelihood of use is selectively displayed.

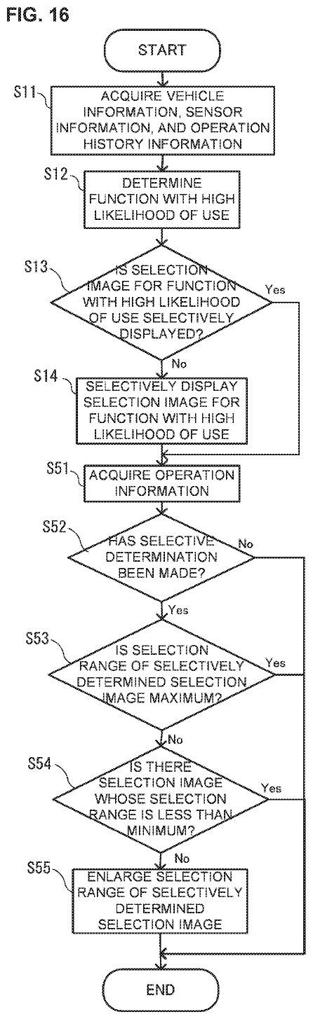

A reference is made to FIG. 16. It is a flowchart according to the twelfth aspect and the thirteenth aspect.

At Step S11, the control unit 20 acquires vehicle information, sensor information, and operation history information.

At Step S12, the control unit 20 determines a function with high likelihood of use based on at least one of the vehicle information, the sensor information, and the operation history information.

At Step S13, the control unit 20 determines whether the selection image 501 corresponding to the function with high likelihood of use is selectively displayed. The process proceeds to Step S14 “when the selection image 501 corresponding to the function with high likelihood of use is not selectively displayed (in the case of No)”, and the process proceeds to Step S51 “when the selection image 501 corresponding to the function with high likelihood of use is selectively displayed (in the case of Yes)”.

At Step S14, the control unit 20 generates the operation image 500 so that the selection image 501 corresponding to the function with high likelihood of use is selectively displayed.

At Step S51, the control unit 20 acquires operation information.

At Step S52, the control unit 20 determines whether the selection image 501 has been selectively determined based on the operation information. The process proceeds to Step S53 “when the selection image 501 has been selectively determined (in the case of Yes),” and the process ends “when the selection image 501 has not been selectively determined (in the case of No)”.

At Step S53, the control unit 20 determines whether the selection range of the selectively determined selection image 501 is the maximum. The process proceeds to Step S54 “when the selection range of the selection image 501 is not the maximum (in the case of No)”, and the process ends “when the selection range of the selection image 501 is the maximum (in the case of Yes)”.

At Step S54, the control unit 20 determines whether the selection range of the different selection image 501 is less than the minimum due to the enlargement of the selection range of the selectively determined selection image 501. The process proceeds to Step S55 “when the selection range of the different selection image 501 is not less than the minimum (in the case of No)”, and the process ends “when the selection range of the different selection image 501 is less than the minimum (in the case of Yes)”.

At Step S55, the control unit 20 generates the operation image 500 such that the selection range of the selectively determined selection image 501 is enlarged.

The present invention described above has the following advantages.

The operation image display device 100 determines a function with high likelihood of use based on at least one of the vehicle information, the sensor information, and the operation history information and selectively displays the selection image corresponding to the function with high likelihood of use, whereby the driver simply needs to check the operation image 500 for a short period of time and perform a pushing operation on the determination operation detecting unit 220 so as to concentrate on driving.

The operation image display device 100 moves the selection image 501 corresponding to the function with high likelihood of use to an upper layer and moves the other selection image 501 corresponding to the function with low likelihood of use to a lower layer, whereby it is possible to collectively display the selection images 501 corresponding to the functions having a high likelihood of use in the upper layer.

The operation image display device 100 fixes the layer and the position of the specific selection image 501 to be displayed, whereby it is possible to prevent the function frequently used by the driver in a specific situation from moving to a different layer while not in use.

As the operation image display device 100 stores the selection range R of the selection image 501 and the maximum and/or the minimum number of the selection images 501 displayed in each layer, it is possible to display the operation image 500 according to the driver's preference.

As the operation image display device 100 displays the selection determination image 503, the driver may be conscious of performing a pushing operation on the central determination operating unit 221, which is capable of exclusively outputting a determination signal, instead of the determination operation detecting unit 220 that simultaneously detects the position of the finger.

Furthermore, although the windshield type HUD is illustrated as the display 10 according to the above-described aspect, a combiner type HUD and a head-mounted display are also applicable.

Further, according to the above-described aspect, the operating unit 200 may be installed on an instrument panel or as an independent remote controller.

Further, according to the above-described aspect, a mobile terminal such as a smartphone or a tablet may be used as the operating unit 200.

Further, according to the above-described aspect, the control unit 20 may communicate with each ECU via a vehicle-mounted LAN and input/output vehicle information without using the vehicle-mounted gateway 301.

Further, according to the above-described aspect, the control unit 20 may further include an external information input/output unit to input/output external information to/from the external communication unit 310 without using the vehicle-mounted gateway 301.

Further, according to the above-described aspect, instead of the selection display image 502, the frame border of the selection image 501 or the line of the icon may be thicker or the color may be darker so as to indicate that the selection image 501 is selectively displayed.

Further, according to the above-described aspect, the return detecting unit 230, another undepicted switch provided in the operating unit 200, or the voice produced by the driver and acquired through the sound sensor 603 may be used to output a determination signal. With this configuration, too, the position of the driver's finger is not detected, and the determination signal may be exclusively output to the control unit 20.

Further, according to the above-described aspect, the layer of the operation image 500 displayed in the display region 101 may be switched based on another undepicted switch provided in the operating unit 200 or a specific gesture on the operation position detecting unit 210.

Furthermore, according to the sixth aspect and the seventh aspect described above, the control unit 20 may simultaneously execute the movement of the selection image 501 to an upper layer and the movement of the different selection image 501 to a lower layer.

Further, according to the above-described thirteenth aspect, the storage unit 40 may store the maximum and/or the minimum selection range of the selection image 501 on a per-layer basis.

The present invention is not limited to the above-described aspect that is illustrated by an example, and those skilled in the art may easily modify the above-described aspect illustrated by an example in the range included in the scope of claims.

### DESCRIPTION OF REFERENCE NUMERALS

1 Vehicle
2 Windshield
10 Display
20 Control unit
21 Condition determining unit
22 Process executing unit
23 Display image generating unit
30 Vehicle information input/output unit
40 Storage unit
60 Sensor information acquisition unit
70 Operation information acquisition unit
100 Operation image display device
101 Display region
200 Operating unit
300 Vehicle-mounted network
500 Operation image
501 Selection image
502 Selection display image
503 Selection determination image
600 Vehicle-mounted sensor

1. An operation image display device comprising:
a display that presents an operation image including a selection image corresponding to a function;
a control unit that controls presentation of the operation image;
an operation information acquisition unit that acquires operation information of an operating unit;
a vehicle information input/output unit that acquires vehicle information;
a sensor information acquisition unit that acquires sensor information; and
a storage unit that stores operation history information in which the vehicle information and/or the sensor information is associated with the operation information, wherein
the control unit determines the function with high likelihood of use based on at least one of the vehicle information, the sensor information, and the operation history information and selectively displays the selection image corresponding to the function with the high likelihood of use.

2. The operation image display device according to claim 1, wherein, when it is determined that an operation has not been performed for a period of time more than a threshold based on the operation information and the operation history information, the control unit selectively displays the selection image corresponding to the function with the high likelihood of use.

3. The operation image display device according to claim 2, wherein the control unit changes the threshold based on at least one of the vehicle information, the sensor information, and the operation history information.

4. The operation image display device according to claim 2, wherein
the control unit determines that selective determination is made when a determination signal is acquired based on the operation information, and
the control unit calculates an operating time from start of an operation to the selective determination based on the operation information and the operation history information and increases the threshold as the operating time increases.

5. The operation image display device according to claim 1, wherein the operation image includes k (k being a natural number equal to or more than 2) or more layers.

6. The operation image display device according to claim 5, wherein the control unit determines the function with low likelihood of use in an n-th layer and moves the selection image corresponding to the function with the low likelihood of use to an (n+m)-th layer (n and m being each a natural number equal to or more than 1 and n+m≤k is satisfied).

7. The operation image display device according to claim 5, wherein the control unit determines the function with the high likelihood of use in an (n+m)-th layer and moves the selection image corresponding to the function with high likelihood of use to an n-th layer (n and m being each a natural number equal to or more than 1 and n+m≤k is satisfied).

8. The operation image display device according to claim 6, wherein
the control unit stores the specific selection image and the specific layer in the storage unit in association with each other, and
the control unit refrains from moving the specific selection image from the specific layer based on the likelihood of use.

9. The operation image display device according to claim 8, wherein the control unit further causes the storage unit to store a display position of the specific selection image.

10. The operation image display device according to claim 5, wherein the control unit causes the storage unit to store a maximum and/or a minimum number of the selection images displayed in one layer.

11. The operation image display device according to claim 10, wherein the storage unit stores the maximum and/or the minimum number of the selection images displayed on a per-layer basis.

12. The operation image display device according to claim 5, wherein the control unit determines a function with high frequency of use based on the operation history information and enlarges a selection range of a selection image corresponding to the function with high frequency of use.

13. The operation image display device according to claim 12, wherein the control unit causes the storage unit to store the maximum and/or the minimum selection range.

14. The operation image display device according to claim 1, wherein
the operating unit includes an operation position detecting unit that detects an operation position and
a central determination operating unit in a center of the operation position detecting unit, and
the control unit causes a selection determination image to be displayed in the center of the operation image.

15. The operation image display device according to claim 1, wherein the control unit gives notification of a change in the presentation of the operation image.

16. An operation image display system comprising:
the operation image display device according to claim 1;
the operating unit that outputs the operation information; and
a vehicle-mounted device and/or an external communication device having the function corresponding to the selection image.

17. An operation image display program causing a computer to operate as the operation image display device according to claim 1.

18. The operation image display device according to claim 3, wherein
the control unit determines that selective determination is made when a determination signal is acquired based on the operation information, and
the control unit calculates an operating time from start of an operation to the selective determination based on the operation information and the operation history information and increases the threshold as the operating time increases.

19. The operation image display device according to claim 7, wherein
the control unit stores the specific selection image and the specific layer in the storage unit in association with each other, and
the control unit refrains from moving the specific selection image from the specific layer based on the likelihood of use.
